(19) United States
(12) Patent Application Publication
(10) Pub. No.: US 2016/0044940 A1
(43) Pub. Date: Feb. 18, 2016

(54) METHOD OF TREATING GRAINS AND TREATED GRAINS

(71) Applicant: BÜHLER AG, Uzwil (CH)

(72) Inventors: Stefania BELLAIO, Winterthur (CH); Stefan KAPPELER, Uzwil (CH); Eliana ZAMPROGNA ROSENFELD, Winterthur (CH); Matthias BENZ, Braunschweig (DE)

(73) Assignee: BUEHLER AG, Uzwil (CH)

(21) Appl. No.: 14/778,782

(22) PCT Filed: Mar. 17, 2014
(86) PCT No.: PCT/EP2014/055317

§ 371 Date: Sep. 21, 2015

(30) Foreign Application Priority Data
Mar. 22, 2013 (EP) 13160566.9

(51) Int. Cl. A23L 1/185; A23B 9/24

(52) U.S. Cl. CPC A23L 1/185; A23B 9/24; A23V 2002/00

(57) ABSTRACT

The invention relates to a method of treating grains, in particular cereal grains, pseudocereal grains or grain legumes, as well as to grains treated with this method. The method comprises the following steps: a) soaking the grains in an aqueous medium, wherein the grains are least temporarily soaked in an aqueous medium comprising at least one reactive oxygen species; b) draining the aqueous medium from the grains; c) tempering the grains and allowing them to at least partially germinate; d) hydrothermally treating the grains for a time in the range from 0.25 h to 4 h at a temperature in the range from 60° C. to 100° C. and at a relative humidity in the range from 60% to 100%.

The present application relates to a method of treating grains, in particular cereal grains, pseudocereal grains or grain legumes, as well as to grains treated with this method.

In WO 2011/151096 A2, a method of preparing flour or splits of legume is disclosed, in which the legume is first allowed to only partially germinate and then milled. As could be shown, a partial germination has several advantages over a complete germination, inter alia an enhanced nutrition (including increased bioavailability of micronutrients like iron, calcium and zinc, increased vitamin content and decreased antinutrient content), improved sensorial properties (including improved taste and activated enzymes) as well as a long shelf life, at least when the products are stabilized after germination.

However, malted grains or partially germinated dry grains have a microbiological quality that is lower than that of the corresponding raw material. This is due to the fact that the malting or partial germination processes also allow the growth of unwanted microorganisms on the surface of the products. These microorganisms include aerobic bacteria, Enterobacteriaceae (such as Coliforms or E. coli), aerobic and anaerobic spore-forming bacteria including Bacillus cereus, Salmonella spp., coagulase-positive Staphylococcus spp., yeasts and moulds. As is well known, E. coli is an indicator for faecal contamination, bacillus cereus may cause foodborne illness (such as vomiting and diarrhoea), and moulds may produce harmful mycotoxins. The national guidelines impose rigorous requirements on food safety. In particular, they demand low contents of such microorganisms.

Several approaches have been made in the past in order to at least reduce the contamination by microorganisms. For example, EP 0 066 270 A2 discloses the treatment of malt with hydrogen peroxide to eliminate undesirable bacterial contamination. In GB 1 025 263, a method of malting barley or other cereal is described, in which the grains are steeped in water containing hydrogen peroxide. On the other hand, U.S. Pat. No. 6,685,979 discloses a process for producing germinated brown rice in which the brown rice is treated with hot water or steam. Furthermore, WO 98/03627 A1, WO 01/47364 A1, WO 94/29430 A1, FR 2 695 649 A1 and U.S. Pat. No. 5,955,070 relate to microbial treatments.

However, none of the documents cited above discloses a method which effectively reduces the numbers of all potentially harmful microorganisms while at the same time not destroying the sensorial, nutritional and functional properties of the grains.

It is therefore an object of the present invention to provide a method of treating grains which effectively reduces the numbers of as many different microorganisms as possible, while at the same time not destroying the sensorial, nutritional and/or functional properties of the grains.

This object is achieved by a method of treating grains according to the present invention, wherein this method comprises the following steps:
a) soaking the grains in an aqueous medium, wherein the grains are least temporarily soaked in an aqueous medium comprising at least one reactive oxygen species;
b) draining the aqueous medium from the grains;
c) tempering the grains and allowing them to at least partially germinate;
d) hydrothermally treating the grains for a time in the range from 0.25 h to 4 h at a temperature in the range from 60° C. to 100° C. and at a relative humidity in the range from 60% to 100%.

Within the present application, a reactive oxygen species is understood as a chemically reactive molecule containing oxygen. Reactive oxygen species include free radicals such as the superoxide anion O₂.⁻, the hydroxyl radical HO., the hydroperoxyl radical HOO., the peroxyl radical ROO. and the alkoxyl radical RO.. Preferably, the reactive oxygen species is a stable molecular oxidant, such as hydrogen peroxide (H₂O₂), peroxy acids, peroxides, ozone (O₃), or any combinations thereof. Hydrogen peroxide was found to be particularly suitable for the purposes of the present invention because it has only a very limited or even no negative effect at all on the sensorial properties of the grains. A peroxy acid has the general structure ROOH, wherein R is any organyl group. An organyl group is to be understood as an organic substituent group, regardless of functional type, having one free valence at a carbon atom, e.g. CH₃CH₂—. A preferred peroxy acid is peracetic acid. A peroxide has the general structure R₁OOR₂, in which R₁ and R₂ may be the same or different organyl groups. In case ozone is contained in the aqueous medium in step a), hydroxyl radicals may be achieved by a high pH value, UV radiation, H₂O₂, or any combination thereof. The reactive oxygen species may also be a food-compatible epoxide, in particular propylene oxide. Reactive oxygen species furthermore include excited oxygen molecules (singlet oxygen ¹O₂).

After an extensive research, in which many different combinations of chemical, physical and biological treatments with various parameters and with several different sequences of the process steps were evaluated, the inventors of the present invention have surprisingly found that the combination of a chemical treatment according to step a) and a hydrothermal treatment according to step d) effectively reduces the numbers of many microorganisms, while at the same time the products obtained by this method also have satisfactory sensorial properties. As will be shown with the help of exemplary embodiments below, this inventive combination of steps yields a synergistic effect going beyond what could have been expected by a person having ordinary skill in the art.

The raw material may have a moisture content in the range from 10% to 14% before soaking step a) is performed.

In step a), the grains may be soaked for a total soaking time in the range from 2 h to 48 h, preferably from 8 h to 32 h, most preferably from 12 h to 20 h. For the vast majority of grains, this time suffices to initiate an at least partial germination of the grains. A soaking time of 2 h is sufficient, for example, when the grains are dehulled buckwheat. On the other hand, soaking times of 48 h may be necessary when the grains are paddy rice.

Step a) may contain two or more sub steps of soaking the grains in a respective aqueous medium, wherein in each sub step, the aqueous medium may or may not contain at least one reactive oxygen species. The invention also encompasses embodiments in which one or more aqueous media comprise no reactive oxygen species at all or reactive oxygen species in a concentration less than 0.1%, preferably less than 0.01% by weight of the respective aqueous medium. Throughout this application, unless otherwise indicated, a concentration of a reactive oxygen species in an aqueous medium is to be understood as a mass fraction, i.e. the fraction of the mass of the reactive oxygen species to the mass of the entire aqueous medium. In particular, the first aqueous medium may be potable water. However, within the scope of the present invention, the aqueous medium of at least one of the sub steps of step a) has to comprise at least one reactive oxygen species. When step a) contains only one soaking step, then this soaking step will subsequently also be referred to as a sub step (which is then the only sub step).

When step a) contains two or more sub steps, then two or more of the aqueous media employed in these sub steps may be identical. In particular, when all aqueous media are identical, they all comprise the same reactive oxygen species. In other embodiments, all aqueous may be different from one another. For example, an aqueous medium employed in a first sub step may contain at least one reactive oxygen species which is different from those contained in an aqueous medium employed in a second sub step and/or the aqueous medium employed in a first sub step may contain a reactive oxygen species in a first concentration which is different from the concentration of this reactive oxygen species in the aqueous medium of a second sub step.

One, several or all of the sub steps in which the aqueous medium comprises at least one reactive oxygen species may be performed for a time in the range from 2 min to 300 min, preferably from 6 min to 180 min, most preferably from 10 min to 120 min, wherein these times may by chosen independently for each such sub step in which the aqueous medium comprises at least one reactive oxygen species.

In one example, step a) may contain the following sub steps:
a1) soaking the grains in a first aqueous medium;
a2) soaking the grains in a second aqueous medium comprising at least one reactive oxygen species.

The first and second aqueous media may be identical; in this case, the first aqueous medium also contains at least one reactive oxygen species. Alternatively, the first aqueous medium may be different from the second aqueous medium. For example, the first aqueous medium may contain at least one reactive oxygen species which is different from those contained in the second aqueous medium and/or the first aqueous medium may contain a reactive oxygen species in a first concentration which is different from the concentration of this reactive oxygen species in the second aqueous medium.

In other embodiments, step a) may comprise the following sub steps:
a1) soaking the grains in a first aqueous medium comprising at least one first reactive oxygen species;
a2) soaking the grains in a second aqueous medium comprising at least one second reactive oxygen species or no reactive oxygen species.

Sub step a1) in these embodiments example may be performed for a time in the range from 2 min to 300 min, preferably from 6 min to 180 min, most preferably from 10 min to 120 min.

In further variants also covered by the invention, step a) may contain the following three sub steps:
a1) soaking the grains in a first aqueous medium comprising at least one first reactive oxygen species;
a2) soaking the grains in a second aqueous medium comprising at least one second reactive oxygen species or no reactive oxygen species;
a3) soaking the grains in a third aqueous medium comprising at least one third reactive oxygen species.

The third aqueous medium may be identical to or different from the first aqueous medium. Sub steps a1) and/or a3) in these variants may be performed for a time in the range from 2 min to 300 min, preferably from 6 min to 180 min, most preferably from 10 min to 120 min, wherein the times of sub steps a1) and a3) may be chosen independently from another.

In still further embodiments, step a) may contain the following three sub steps:
a1) soaking the grains in a first aqueous medium comprising at least one first reactive oxygen species or no reactive oxygen species;
a2) soaking the grains in a second aqueous medium comprising at least one second reactive oxygen species;
a3) soaking the grains in a third aqueous medium comprising at least one third reactive oxygen species or no reactive oxygen species.

Sub step a2) in these embodiments may be performed for a time in the range from 2 min to 300 min, preferably from 6 min to 180 min, most preferably from 10 min to 120 min.

In one embodiment, the soaking in step a) or in one, several or all sub steps of step a) is performed by immersing the grains in a surplus of the aqueous medium. Alternatively, the soaking in step a) or in one, several or all sub steps of step a) may be performed by sprinkling the aqueous solution onto the grains.

In one, several or all of the aqueous media comprising at least one reactive oxygen species, i. e. in one, several or all sub steps of step a), this reactive oxygen species may be present in a concentration in the range from 0.5% to 5%, preferably from 0.75% to 3%, most preferably from 0.9% to 1.5% by weight of the aqueous medium, wherein these concentrations may be chosen independently from one another. These ranges are particularly suitable when the reactive oxygen species is hydrogen peroxide.

Smaller concentrations would make the chemical treatment in step a) less effective. On the other hand, higher concentrations would lead to an increased degradation of the grains, in particular in terms of the sensorial properties.

One, several or all of the aqueous media employed in step a), i. e. the aqueous medium in one, several or all sub steps of step a), may have a temperature in the range from 15° C. to 30° C., preferably from 18° C. to 28° C., more preferably from 18° C. to 25° C., even more preferably from 20° C. to 26° C. and most preferably from 20° C. to 23° C. Thus, at least under many geographical and temporal conditions, step a) or at least one or several of its sub steps may be performed at room temperature, so that no cooling or heating of the aqueous medium is necessary.

Optionally, during step a), in particular in one, several or all of its sub steps, the grains and the aqueous medium may be mixed in order to provide homogeneous soaking conditions. However, it is preferred that the mixing occurs discontinuously—for example only during one, two or three separated time intervals during step a), in particular during one, several or all of its sub steps.

Step c) may be performed at a temperature in the range from 14° C. to 30° C., preferably from 16° C. to 27° C., most preferably from 18° C. to 24° C. Temperatures in this range are sufficient for an at least partial germination of the grains. Similar to what has been explained above, at least under many geographical and temporal conditions, step c) may be performed at room temperature, so that no cooling or heating is necessary.

The relative humidity in step c) may be in the range from 75% to 100%, preferably from 80% to 98%, most preferably from 85% to 96%.

Step c) may be performed for a time in the range from 12 h to 96 h, preferably from 24 h to 72 h, most preferably from 36 h to 54 h.

The hydrothermal treatment in step d) may be performed at a temperature in a range from 50° C. to 100° C., preferably from 60° C. to 80° C.

The hydrothermal treatment in step d) may be performed for a time in the range from 0.5 h to 3.5 h, preferably from 1 h to 3 h, most preferably from 1.5 h to 2.5 h.

The relative humidity during the hydrothermal treatment in step d) may be in the range from 70% to 100%, preferably from 80% to 98%, more preferably from 85% to 96%, most preferably from 90% to 96%.

After step d), the grains may be dried. The optional drying may be performed by air-drying, freeze-drying, roasting, infrared roasting, vacuum-drying, micro wave-drying, infrared drying, or any combination thereof, wherein air-drying is preferred. During the optional drying step, the grains may be mixed, wherein this mixing preferably occurs continuously. The drying may be performed under any one, any two or all three of the following conditions:
Drying may be performed for a time in the range from 8 h to 30 h, preferably from 12 h to 24 h.
Drying may be performed at a temperature of the drying medium (in particular air) in the range from 40° C. to 100° C., preferably from 50° C. to 80° C.
Drying may be performed at a relative humidity of the drying medium (in particular air) in the range from 2% to 20%, preferably from 3% to 12%.

The grains may be dried to a moisture content in the range from 10% to 14%.

The invention also covers methods which do not comprise any drying step. Instead, the grains obtained after step d) may be further processed directly without any drying.

After the optional drying, the grains may be cooled. Preferably, the grains are mixed during cooling, in particular continuously mixed. The cooling may be performed under any one, any two or all three of the following conditions:
The cooling time may be in the range from 0.5 h to 4 h, preferably from 1 h to 3 h.
The cooling may occur at a temperature in the range from 20° C. to 40° C., preferably from 25° C. to 35° C.
The relative humidity during cooling may be in the range from 10% to 60%, preferably from 20% to 40%.

The parameters described above have shown to be particularly suitable when the grains are wheat grains. However, the grains may also be other cereal grains, such as rye, barley, oat, rice (in particular paddy rice or brown rice), maize, millet, sorghum or triticale. Moreover, the grains may also be pseudocereal grains (such as buckwheat, quinoa or amaranth) or grain legumes (such as beans, black beans, mung beans, fava beans, soybeans, lima beans, runner beans, peas, yellow peas, green peas, chickpeas, brown chickpeas, pigeon peas, cowpeas, lentils, green gram, lupins, or peanuts).

A further aspect of the present invention relates to grains obtained by a method as described above. In particular, the grains may have decreased populations of one or several harmful microorganisms compared to grains obtained by conventional methods, while at the same time their sensorial, nutritional and/or functional properties are not destroyed.

The grains may be dehusked after step d) and the optional subsequent steps of drying and cooling. When the grains are grain legumes, they may be split after step d) and the optional subsequent steps of drying, cooling and dehusking. After step d) and the optional subsequent steps of drying, cooling, dehusking and splitting, the grains may be milled to obtain, for example, flour.

The invention will now be further illustrated with the help of several inventive and comparative examples, in which the grains are wheat grains. Table 1 shows an overview of the examples, including the treatment conditions and the results of the micro-biological and/or sensorial analysis.

TABLE 1

| | | | | | | | | | Germi- | Seed- |
|---|---|---|---|---|---|---|---|---|---|---|
| | | | | | | | | | nation | ling |
| Example | | tₐ₁ | tₐ₂ | | | t_{d} | T_{d} | RH_{d} | degree | length |
| no. | Comment | (h) | (min) | c | | (min) | (° C.) | (%) | (%) | (mm) |
| 1 (non- | raw wheat | — | — | — | | — | — | — | — | — |
| inventive) | | | | | | | | | | |
| 2 (non- | neither soaking | 16 | — | — | | — | — | — | 100 | 5-18 |
| inventive) | in aqueous | | | | | | | | | |
| | medium with H₂O₂ | | | | | | | | | |
| | nor | | | | | | | | | |
| | hydrothermal | | | | | | | | | |
| | treatment | | | | | | | | | |
| 3 (non- | only | 16 | — | — | | 60 | 60 | 99 | 100 | 5-18 |
| inventive) | hydrothermal | | | | | | | | | |
| | treatment, but | | | | | | | | | |
| | no soaking in | | | | | | | | | |
| | aqueous medium | | | | | | | | | |
| | with H₂O₂ | | | | | | | | | |
| 4 (non- | only soaking in | 16 | 10 | 5 | wt % | — | — | — | 95 | 1-15 |
| inventive) | aqueous medium | | | | | | | | | |
| | with H₂O₂, but | | | | | | | | | |
| | no hydrothermal | | | | | | | | | |
| | treatment | | | | | | | | | |
| 5 | | 16 | 10 | 5 | wt % | 60 | 60 | 99 | 95 | 5-15 |
| 6 | | 15 | 50 | 1 | wt % | 60 | 60 | 99 | 100 | 5-15 |
| 7 | | 14 | 120 | 1 | wt % | 60 | 60 | 99 | 100 | 5-25 |
| 8 | H₂O₂ added by | 15 | 60 | 5 | wt % | 60 | 60 | 99 | 80 | 1-10 |
| | sprinkling | | | | | | | | | |
| 9 | H₂O₂ added by | 14 | 120 | 5 | wt % | 60 | 60 | 99 | 95 | 5-25 |
| | sprinkling | | | | | | | | | |
| 10 | H₂O₂ added by | 14 | 120 | 2.5 | wt % | 120 | 60 | 60 | 90 | 5-15 |
| | sprinkling | | | | | | | | | |
| 11 | | 14 | 120 | 1 | wt % | 60 | 60 | 99 | 95 | 5-25 |
| 12 (non- | H₂O₂ added after | 16 | 10 | 5 | wt % | — | — | — | 95-100 | 1-20 |
| inventive) | tempering | | | | | | | | | |
| 13 (non- | calcium, | 16 | 10 | 20 | g/l | — | — | — | 65 | 1-2 |
| inventive) | hypochlorite | | | | | | | | | |
| | added in step a) | | | | | | | | | |
| 14 (non- | calcium | 16 | 10 | 20 | g/l | — | — | — | 100 | 3-15 |
| inventive) | hypochlorite | | | | | | | | | |
| | added after | | | | | | | | | |
| | tempering | | | | | | | | | |
| 15 (non- | H₂O₂ added after | 16 | 10 | 5 | wt % | 60 | 60 | 99 | 95 | 5-15 |
| inventive) | tempering | | | | | | | | | |
| 16 (non- | H₂O₂ added after | 16 | 10 | 5 | wt % | 60 | 80 | 99 | 95 | 5-15 |
| inventive) | tempering | | | | | | | | | |
| 17 | | 14 | 120 | 1 | wt % | 120 | 60 | 60 | 90 | 5-15 |
| 18 | | — | 960 | 1 | wt % | 120 | 60 | 90 | 90 | 5-15 |
| 19 | | 16 | 10 | 5 | wt % | 60 | 80 | 99 | 95 | 5-15 |

| | Total | | | | | | |
|---|---|---|---|---|---|---|---|
| | aerobic | Entero- | Coli- | | | | |
| Example | count | bacteriaceae | forms | B. cereus | Yeasts | Moulds | |
| no. | (lg 10) | (lg 10) | (lg 10) | (lg 10) | (lg 10) | (lg 10) | Quality change |
| 1 (non- | 5.6 | 5.4 | 5.2 | n.d. | 3.05 | 2.7 | |
| inventive) | | | | | | | |
| 2 (non- | 8.35 | 8 | 8 | 5.2 | 4 | 3.1 | |
| inventive) | | | | | | | |
| 3 (non- | 5.53 | 4.23 | 4.20 | n.d. | 5.24 | 1.80 | no quality change |
| inventive) | | | | | | | |
| 4 (non- | 8.45 | 8.4 | 8.15 | n.d. | 3.5 | 1.5 | no quality change |
| inventive) | | | | | | | |
| 5 | 3.4 | 2.8 | 2.8 | 2.3 | n.d. | n.d. | no quality change |
| 6 | 4.3 | 1.5 | 1.5 | 4 | n.d. | n.d. | no quality change |
| 7 | 5.2 | n.d. | n.d. | 4.8 | n.d. | n.d. | no quality change |
| 8 | 5.5 | 6.4 | 6.2 | 6.4 | n.d. | n.d. | no quality change |
| 9 | 3.6 | n.d. | n.d. | 2.9 | n.d. | n.d. | no quality change |
| 10 | 7.2 | 6.8 | 6.6 | n.d. | 5.3 | 4.7 | no quality change |
| 11 | 3.6 | n.d. | n.d. | 3 | n.d. | n.d. | no quality change |
| 12 (non- | 7.8 | 7.65 | 7.5 | 4.7 | n.d. | n.d. | no quality change |
| inventive) | | | | | | | |
| 13 (non- | 7.6 | 7.6 | 7.2 | n.d. | 3.6 | n.d. | reduced |
| inventive) | | | | | | | germination |
| 14 (non- | 7.4 | 7 | 6.8 | 4.4 | n.d. | n.d. | inferior smell |
| | | | | | | | (mostly sour) |
| | | | | | | | and look (bleached) |
| 15 (non- | 5.2 | 2.8 | 2.8 | 4.9 | n.d. | n.d. | no quality change |
| inventive) | | | | | | | |
| 16 (non- | 5.0 | 2.4 | 2.4 | 4.8 | n.d. | n.d. | no quality change |
| inventive) | | | | | | | |
| 17 | 7.7 | 7.5 | 7.5 | 5.5 | 5.1 | n.d. | no quality change |
| 18 | 4 | 2.8 | 1.5 | n.d. | 2.3 | 2.5 | no quality change |
| 19 | 4.3 | 2.6 | 2.6 | 2.7 | n.d. | n.d. | no quality change |

Subsequently, the examples will first be described, and then the results summarized in Table 1 will be discussed.

### EXAMPLE 1

### Non-Inventive

This example only contains raw wheat grains, which have not undergone any treatment (neither a soaking nor a hydrothermal treatment).

### EXAMPLE 2

### Non-Inventive

Example 2 are wheat grains which have undergone the following treatment steps:
a) soaking the grains for a time of 16 hours by immersing them in a surplus of an aqueous medium without any reactive oxygen species at a temperature of 20° C.;
b) draining the aqueous medium from the grains;
c) tempering the grains for a time of 48 hours at a temperature of 20° C. and at a relative humidity of 95%, thereby allowing the grains to at least partially germinate.

No further treatment (in particular no further treatment according to step d) of the present invention) was performed afterwards.

### EXAMPLE 3

### Non-Inventive

The wheat grains underwent only a hydrothermal treatment for a time of 60 minutes at a temperature of 60° C. and a relative humidity of 99%. No soaking was performed prior to this hydrothermal treatment.

### EXAMPLE 4

### Non-Inventive

In this example, the wheat grains underwent the following treatment steps:
a1) soaking the grains for a time of 16 hours by immersing them in a surplus of a first aqueous medium containing no reactive oxygen species at a temperature of 20° C.;
a2) soaking the grains for 10 minutes by immersing them in a surplus of a second aqueous medium comprising 5% by weight of H₂O₂ at a temperature of 20° C.;
b) draining the second aqueous medium from the grains;
c) tempering the grains for a time of 48 h at a temperature of 20° C. and a relative humidity of 95%, thereby allowing the grains to at least partially germinate.

No further treatments (in particular no hydrothermal treatments according to step d)) were performed afterwards.

### EXAMPLE 5

### Inventive

The same steps were performed as in Example 4. Subsequently, in a step d), the grains were hydrothermally treated at a temperature of 60° C. and a relative humidity of 99% for a time of 60 minutes.

### EXAMPLE 6

### Inventive

The same steps were performed as in Example 5. However, the second aqueous medium contained only 1% by weight of H₂O₂. Moreover, the second soaking in step a2) was performed for 50 minutes.

### EXAMPLE 7

### Inventive

The same steps as in Example 6 were performed. However, the soaking in the second aqueous solution containing H₂O₂ took place for 120 minutes.

### EXAMPLE 8

### Inventive

In this example, as opposed to Example 5, the second soaking in sub step a2) was performed by sprinkling a solution containing 5% by weight of H₂O₂ onto the grains for a time of 60 minutes.

### EXAMPLE 9

### Inventive

As opposed to Example 8, the sprinkling was performed for 2 h.

### EXAMPLE 10

### Inventive

In a further variation of Example 9, the concentration of H₂O₂ was only 2.5% by weight.

### EXAMPLE 11

### Inventive

In this example, the same parameters were used as Example 7.

### EXAMPLE 12

### Non-Inventive

As opposed to Example 4, the second aqueous solution was added to the grains after the tempering step c).

### EXAMPLE 13

### Non-Inventive

In this example, as opposed to Example 12, calcium hypochlorite was used as reactive oxygen species instead of H₂O₂.

### EXAMPLE 14

### Non-Inventive

In contrast to Example 13, calcium hypochlorite was added after tempering step c).

### EXAMPLE 15

### Non-Inventive

In this example, a soaking in water for 16 h was followed by a tempering and germination for 48 h. After this tempering (and thus not in accordance with the present invention), the grains were immersed in a solution comprising 5% by weight of H₂O₂ for 10 minutes. Then a drying was performed for 1 h at a temperature of 60° C. and a relative humidity of 99%.

### EXAMPLE 16

### Non-Inventive

In contrast to Example 15, drying was performed at a temperature of 80° C.

### EXAMPLE 17

### Inventive

This example is similar to Examples 5 to 7, with the parameters indicated in Table 1.

### EXAMPLE 18

### Inventive

In Example 18, only one soaking step in an H₂O₂ solution was performed, without any prior soaking in water.

### EXAMPLE 19

### Inventive

In this example, the same parameters were used as in Example 5—with the exception that the hydrothermal treatment was performed at a temperature of 80° C.

Table 1 shows the following treatment parameters and results for all examples:
tₐ₁: time of first soaking in sub step a1), in which the first aqueous medium does not contain any reactive oxygen species;
c: concentration of H₂O₂ in the second aqueous medium;
tₐ₂: time of second soaking in sub step a2), in which the second aqueous medium comprises H₂O₂;
t_{d}: time of hydrothermal treatment in step d);
T_{d}: temperature during hydrothermal treatment in step d);
RH_{d}: relative humidity during hydrothermal treatment in step d);
Germination degree: percentage of the grains which have at least partially germinated;
Seedling length: range of lengths of the seedlings developed during germination;
Total aerobic count (1 g 10): base-10 logarithm of CFU/g of aerobic bacteria (CFU/g: colony-forming units per gram);
Enterobacteriaceae (1 g 10): base-10 logarithm of CFU/g of Enterobacteriaceae;
Coliforms (1 g 10): base-10 logarithm of CFU/g of Coliforms;
B. cereus (1 g 10): base-10 logarithm of CFU/g of B. cereus;
Yeasts (1 g 10): base-10 logarithm of CFU/g of yeasts;
Moulds (1 g 10): base-10 logarithm of CFU/g of moulds;
Quality change: changes in the product quality compared to raw product of Example 1.

In Table 1, “n.d.” means that no contamination could be detected.

### DISCUSSION

A comparison of Examples 1 and 2 shows that germination without any chemical or hydrothermal treatment leads to an excessive increase in all six measured microbiological contaminations. In Example 3, at least some of the contaminations decreased when the grains had undergone a hydrothermal treatment. According to Example 4, at least some of the others contaminations decreased when the grains were soaked in an aqueous medium comprising H₂O₂. However, several populations (total aerobic, Enterobacteriaceae and Coliforms) increased. The latter three populations could only be decreased by additionally performing a hydrothermal treatment according to step d) of the present application. Within the examples described herein, Examples 9 and 11 provided the best overall results.

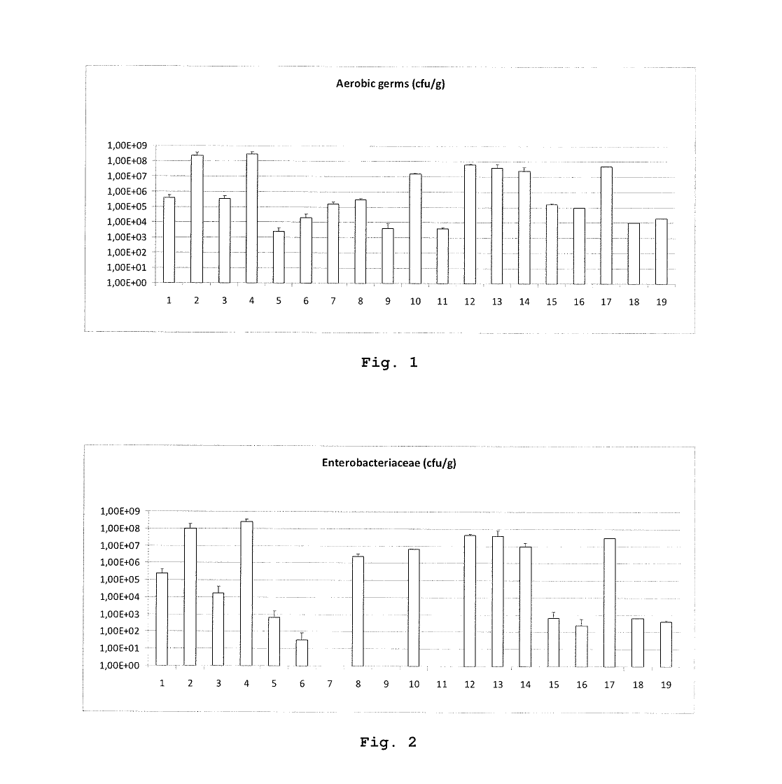

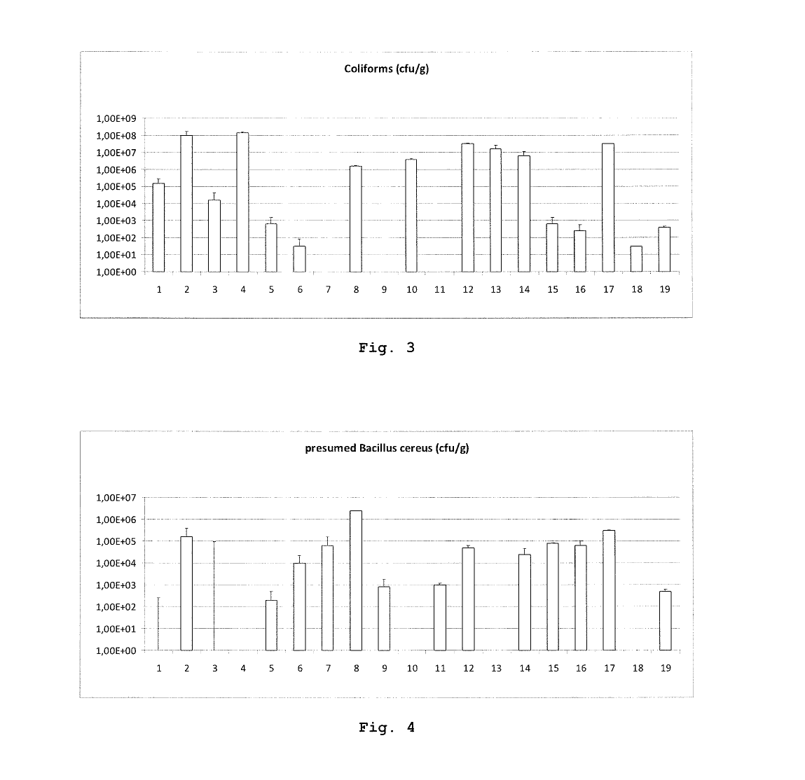

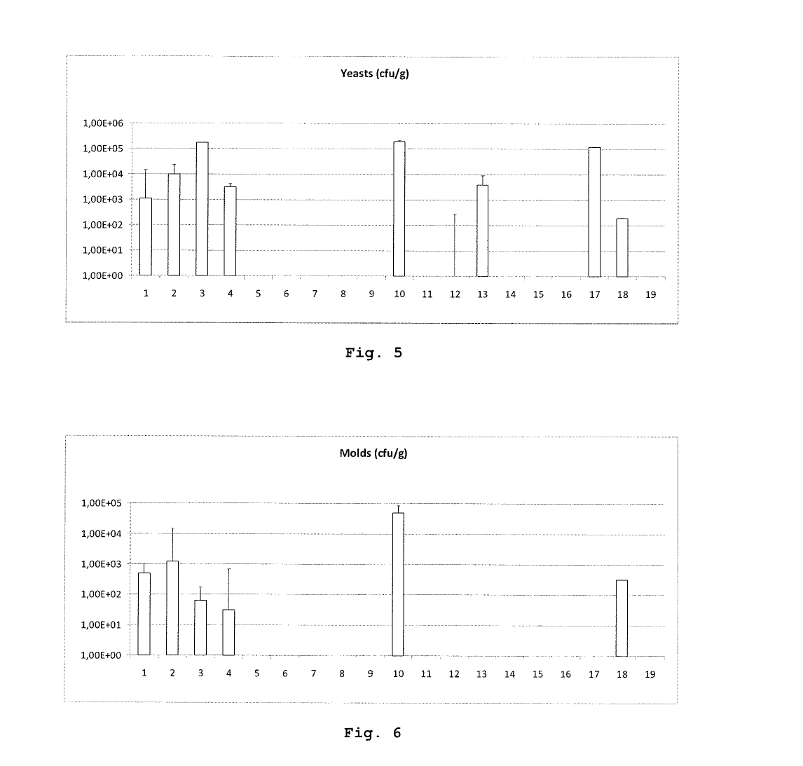

FIGS. 1 to 6 graphically show the six populations for Examples 1 to 18. For Examples 1 to 17, the figures also include error bars providing the standard deviations for several repeated measurements within the same example; Example 18 does not contain error bars because the measurement was not done in duplicate.

The synergistic effect of the present invention can be demonstrated, for example, by comparing the total aerobic count and the contaminations by Enterobacteriaceae and Coliforms for Examples 2 to 5: If no hydrothermal treatment according to step d) is present, then all three populations increase when a soaking in an aqueous medium comprising H₂O₂ is added (Example 4 vs. Example 2). However, when a hydrothermal treatment is performed, then an additional soaking in an aqueous medium comprising H₂O₂ leads to a decrease (Example 5 vs. Example 3). On the other hand, when no soaking in an aqueous medium comprising H₂O₂ is performed, then the amount of yeasts increases (Example 3 vs. Example 2). However, when the grains are soaked in an aqueous medium comprising H₂O₂, then the additional hydrothermal treatment pushes the amount of yeasts below the measurable limit (Example 5 vs. Example 4).

Non-inventive Examples 12 to 14 also show that in the absence of a hydrothermal treatment, the total aerobic count as well as the contaminations by Enterobacteriaceae and by Coliforms is higher than in the inventive Examples 5 to 11.

Calcium hypochlorite (non-inventive Examples 13 and 14) also reduces the contaminations with respect to an uncontrolled germination according to Example 2. However, calcium hypochlorite also reduces germination (germination degree as well as seedling length) or produces grains with inferior smell (mostly sour) and look (bleached). On the other hand, for none of the treatments involving H₂O₂ (Examples 4 to 12), a quality change was observed.

Moreover, in non-inventive Examples 12 and 14, the second aqueous solution is added to the grains after tempering step c). This reduces most of the contaminations with respect to a soaking before draining and tempering (non-inventive Examples 4 and 12, respectively). However, the contamination by B. cereus severely increases.

In non-inventive Examples 15 and 16, H₂O₂ was added only after tempering. Several of the contaminations are higher than they are for the inventive examples. For example, the total aerobic count in non-inventive Examples 15 and 16 was higher than in inventive Examples 5, 6, 9 and 11. The population be Enterobacteriaceae in non-inventive Examples 15 and 16 was higher than in inventive Examples 6, 7, 9 and 11.

Pilot trials were also carried out with a batch size of 55 kg wheat at an independent scientific institute. The following microbial groups were determined from the pilot: total count of aerobic bacteria; aerobic and anaerobic spore-forming bacteria including Bacillus cereus group; Enterobacteriaceae, Coliforms, Salmonella spp.; coagulase-positive Staphylococcus spp.; yeasts and moulds.

This study clearly showed the importance of raw material quality. Germination conditions in a state-of-the-art process (no combined steps of hydrogen peroxide soaking and hydrothermal treatment prior to drying) were rather favorable for microbial growth, as shown in FIG. 7, where the populations are depicted at the following stages of the process:
W: wheat sample prior to processing,
S: grains after 8 h of soaking,
G: grains after 68 h of germination,
M: final product after drying and cooling.

B. cereus, E. coli, Staphylococcus spp. or Salmonella spp. were not detected in any samples.

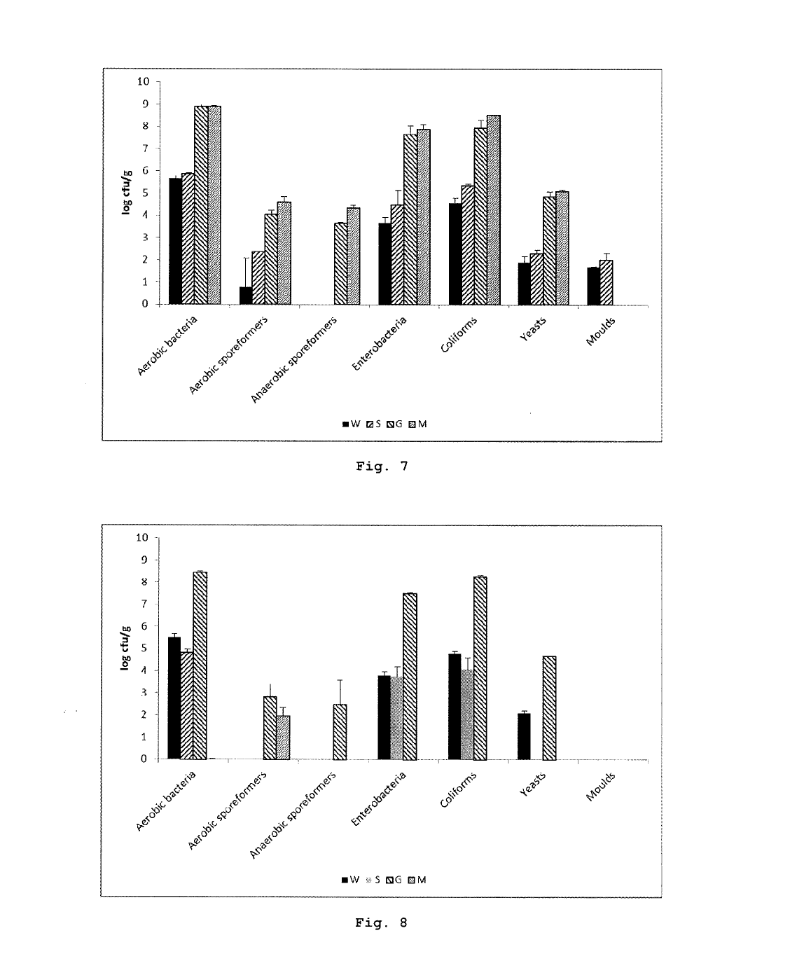

However, this study revealed that the “hurdle concept” according to the present invention (including the combined steps of hydrogen peroxide soaking and hydrothermal treatment prior to drying) effectively suppressed the growth of bacteria and yeasts, as shown in FIG. 8.

1. A method of treating grains, comprising the following steps:
a) soaking the grains in an aqueous medium, wherein the grains are at least temporarily soaked in an aqueous medium comprising at least one reactive oxygen species;
b) draining the aqueous medium from the grains;
c) tempering the grains and allowing them to at least partially germinate;
d) hydrothermally treating the grains for a time in the range from 0.25 h to 4 h at a temperature in the range from 60° C. to 100° C. and at a relative humidity in the range from 60% to 100%.

2. The method of claim 1,
characterized in that
step a) contains one, two or more sub steps of soaking the grains in a respective aqueous medium, wherein one, several or all of the sub steps in which the aqueous medium comprises at least one reactive oxygen species is performed for a time in the range from 2 min to 300 min, preferably from 6 min to 180 min, most preferably from 10 min to 120 min.

3. The method according to claim 1,
characterized in that
step a) contains the following sub steps:
a1) soaking the grains in a first aqueous medium;
a2) soaking the grains in a second aqueous medium comprising at least one reactive oxygen species.

4. The method according to claim 1,
characterized in that
in one, several or all of the aqueous media comprising at least one reactive oxygen species, this reactive oxygen species is present in a concentration in the range from 0.5% to 5%, preferably from 0.75% to 3%, most preferably from 0.9% to 1.5% by weight of the aqueous medium.

5. The method according to claim 1,
characterized in that
one, several or all of the aqueous media of step a) have a temperature in the range from 15° C. to 30° C., preferably from 18° C. to 28° C., more preferably from 18° C. to 25° C., even more preferably from 20° C. to 26° C. and most preferably from 20° C. to 23° C.

6. The method according to claim 1,
characterized in that
the grains are soaked in step a) for a total soaking time in the range from 2 h to 48 h, preferably from 8 h to 32 h, most preferably from 12 h to 20 h.

7. The method according to claim 1,
characterized in that
step c) is performed at a temperature in the range from 14° C. to 30° C., preferably from 16° C. to 27° C., most preferably from 18° C. to 24° C.

8. The method according to claim 1,
characterized in that
step c) is performed at a relative humidity in the range from 75% to 100%, preferably from 80% to 98%, most preferably from 85% to 96%.

9. The method according to claim 1,
characterized in that
step c) is performed for a time in the range from 12 h to 96 h, preferably from 24 h to 72 h, most preferably from 36 h to 54 h.

10. The method according to claim 1,
characterized in that
the hydrothermal treatment in step d) is performed at a temperature in the range from 50° C. to 100° C., preferably from 60° C. to 80° C.

11. The method according to claim 1,
characterized in that
the hydrothermal treatment in step d) is performed for a time in the range from 0.5 h to 3.5 h, preferably from 1 h to 3 h, most preferably from 1.5 h to 2.5 h.

12. The method according to claim 1,
characterized in that
the hydrothermal treatment in step d) is performed at a relative humidity in the range from 70% to 100%, preferably from 80% to 98%, more preferably from 85% to 96%, most preferably from 90% to 96%.

13. The method according to claim 1,
characterized in that
the reactive oxygen species is selected from the group consisting of hydrogen peroxide, peroxy acids (in particular peracetic acid), peroxides, ozone, food-compatible epoxides, or any combinations thereof.

14. The method according to claim 1,
characterized in that
the grains are selected from the group consisting of cereal grains (such as wheat, rye, barley, oat, rice (in particular paddy rice or brown rice), maize, millet, sorghum or triticale), pseudocereal grains (such as buckwheat, quinoa or amaranth) or grain legumes (such as beans, black beans, mung beans, fava beans, soybeans, lima beans, runner beans, peas, yellow peas, green peas, chickpeas, brown chickpeas, pigeon peas, cowpeas, lentils, green gram, lupins, or peanuts).

15. Grains obtained by a method according to claim 1.
